(19) United States
(12) Patent Application Publication
(10) Pub. No.: US 2014/0002233 A1
(43) Pub. Date: Jan. 2, 2014

(54) WIRELESS CONTROL MODULE AND DOCKING APPARATUS

(71) Applicants: Ronald J Miller, Beavercreek, OH (US); James Good, Centerville, OH (US)

(72) Inventors: Ronald J Miller, Beavercreek, OH (US); James Good, Centerville, OH (US)

(73) Assignee: INTERACTIVE CONTROL SOLUTIONS, LLC, Beavercreek, OH (US)

(21) Appl. No.: 14/003,844

(22) PCT Filed: Feb. 15, 2012
(86) PCT No.: PCT/US12/25241

§ 371 Date: Sep. 9, 2013

Related U.S. Application Data
(60) Provisional application No. 61/451,876, filed on Mar. 11, 2011.

(51) Int. Cl. G05B 1/01

(52) U.S. Cl. CPC G05B 1/01
USPC 340/3.1

(57) ABSTRACT

A device for monitoring and controlling the operation of an individual piece of Utilization Equipment or an Alternate Electrical Source, the Module linked to an individual piece of Utilization Equipment or an Alternate Electrical Source via a Docking Apparatus.

A device for monitoring and controlling the operation of an individual piece of Utilization Equipment or an Alternate Electrical Source, the device comprising a Wireless Control Module linked to an individual piece of Utilization Equipment or to an

Alternate Electrical Source via a Docking Apparatus, and wirelessly communicates with a Computer System using radio frequency communication. A Wireless Control Module and a Docking Apparatus can be provided as one unit.

A Wireless Control Module and a Docking Apparatus represent a broad concept for controlling a piece of Utilization Equipment in an electrical architecture. The specific examples presented in this description are for illustrative purposes only.

These and additional features provided by the embodiments described herein will be more fully understood in view of the following detailed description, in conjunction with the drawings.

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

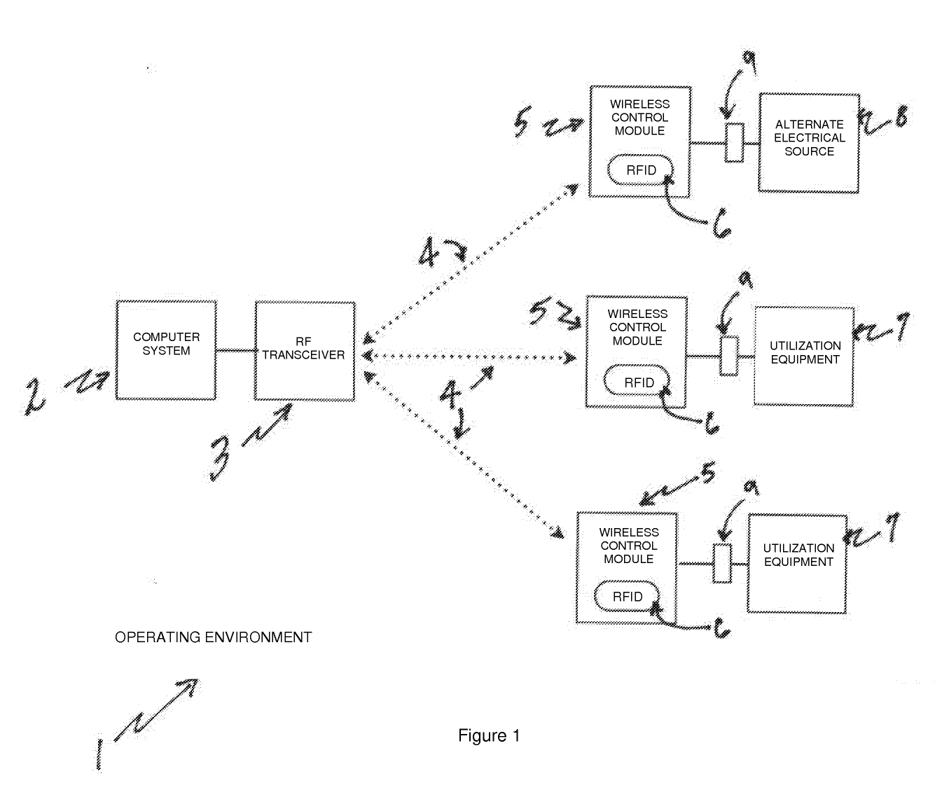

FIG. 1 depicts a device for monitoring and controlling the operation of an individual piece of Utilization Equipment or an Alternate Electrical Source according to one or more embodiments shown and described herein;

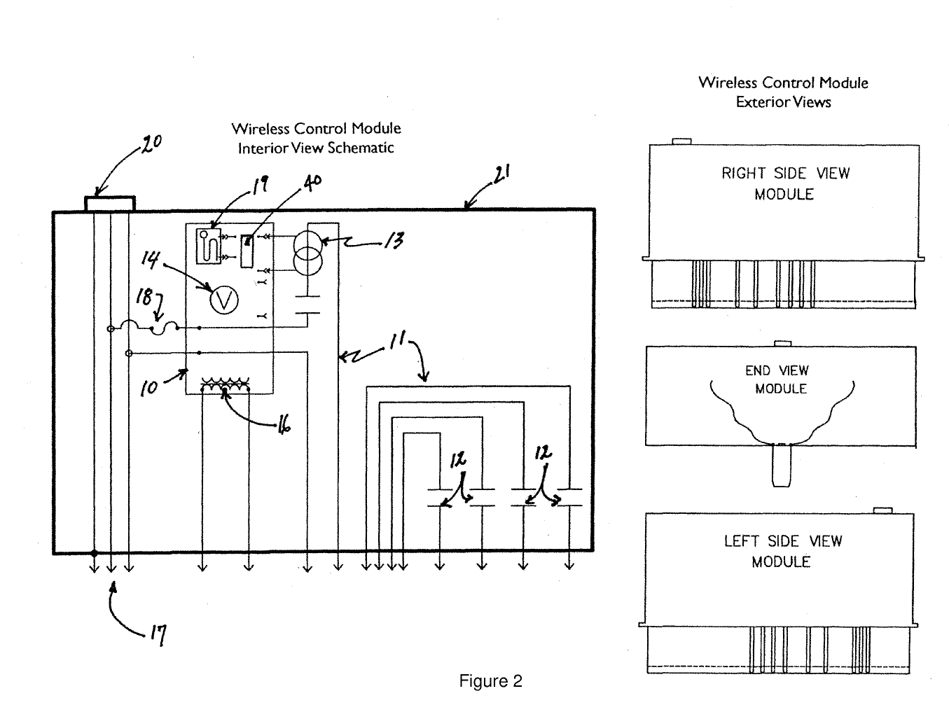

FIG. 2 depicts electrical and mechanical components of a Wireless Control Module of a device for monitoring and controlling the operation of an individual piece of Utilization Equipment or an Alternate Electrical Source according to one or more embodiments shown and described herein;

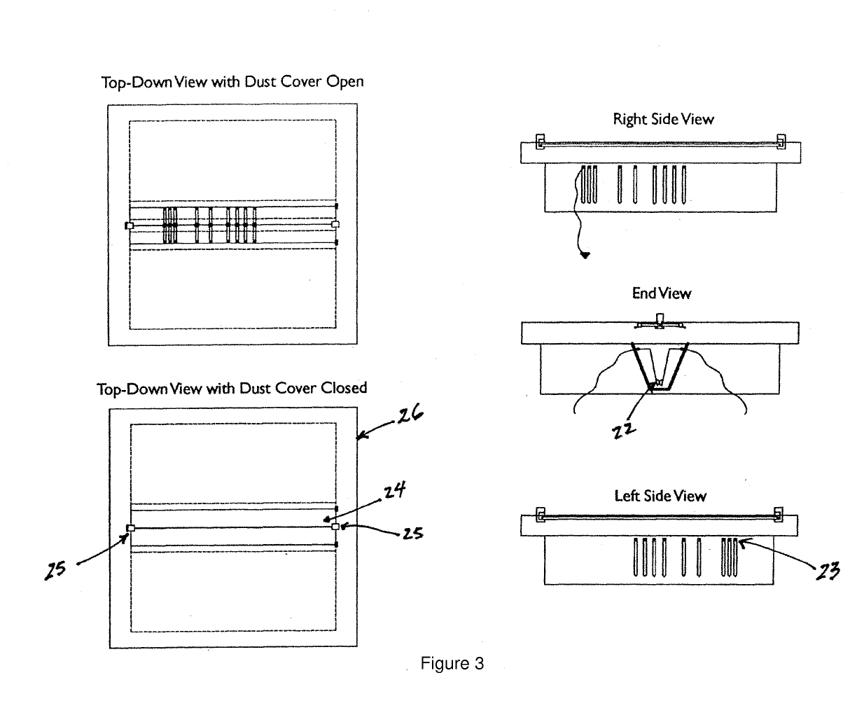

FIG. 3 depicts electrical and mechanical components of a Docking Apparatus of a device for monitoring and controlling the operation of an individual piece of Utilization Equipment or an Alternate Electrical Source according to one or more embodiments shown and described herein;

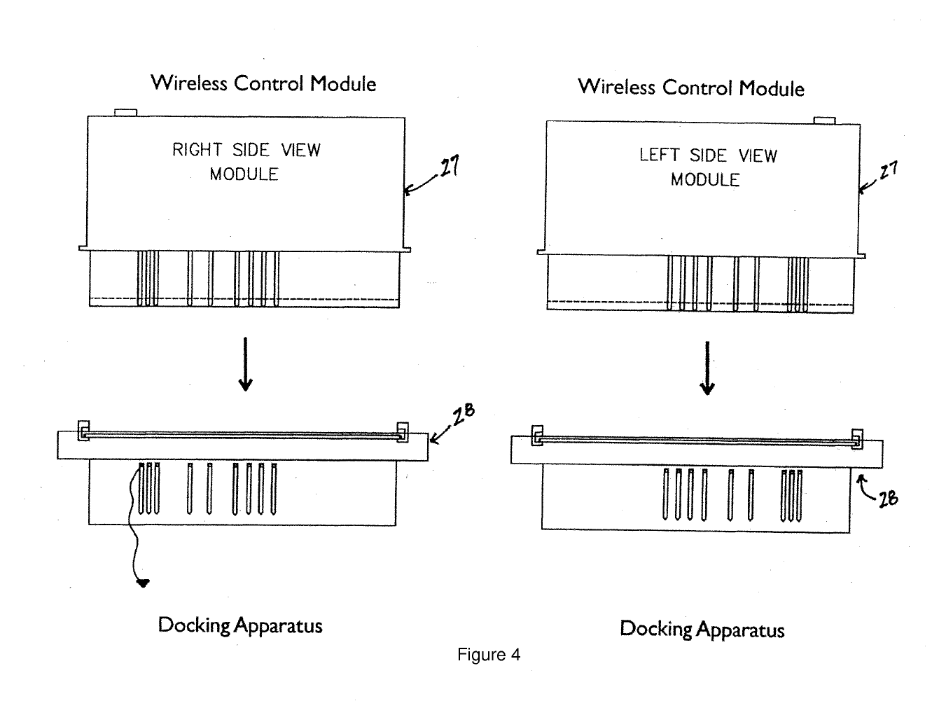

FIG. 4 depicts a Wireless Control Module that plugs-in to a Docking Apparatus of a device for monitoring and controlling the operation of an individual piece of Utilization Equipment or an Alternate Electrical Source according to one or more embodiments shown and described herein;

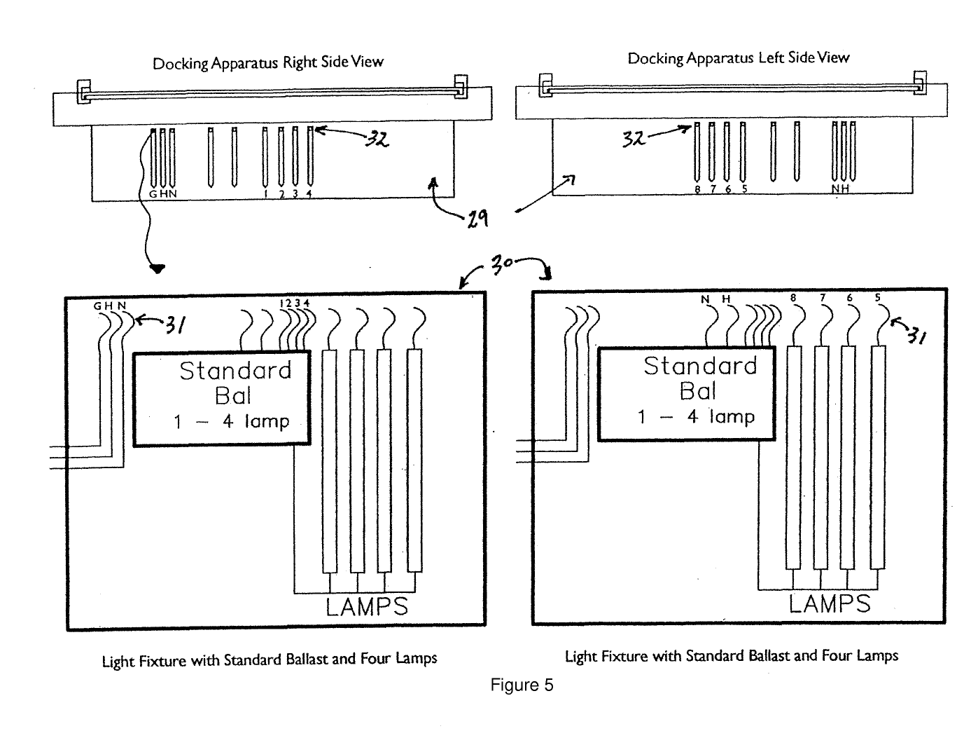

FIG. 5 depicts a Docking Apparatus attached and hardwired to a piece of Utilization Equipment of a device for monitoring and controlling the operation of an individual piece of Utilization Equipment or an Alternate Electrical Source according to one or more embodiments shown and described herein;

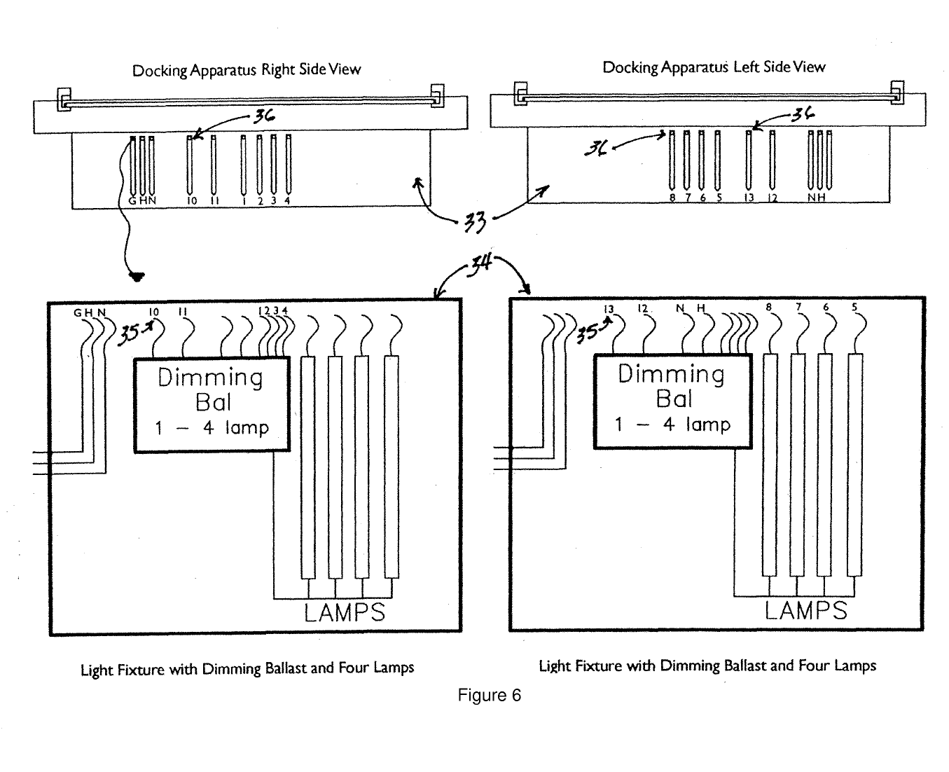

FIG. 6 depicts a Docking Apparatus attached and hardwired to a piece of Utilization Equipment of a device for monitoring and controlling the operation of an individual piece of Utilization Equipment or an Alternate Electrical Source according to one or more embodiments shown and described herein; and

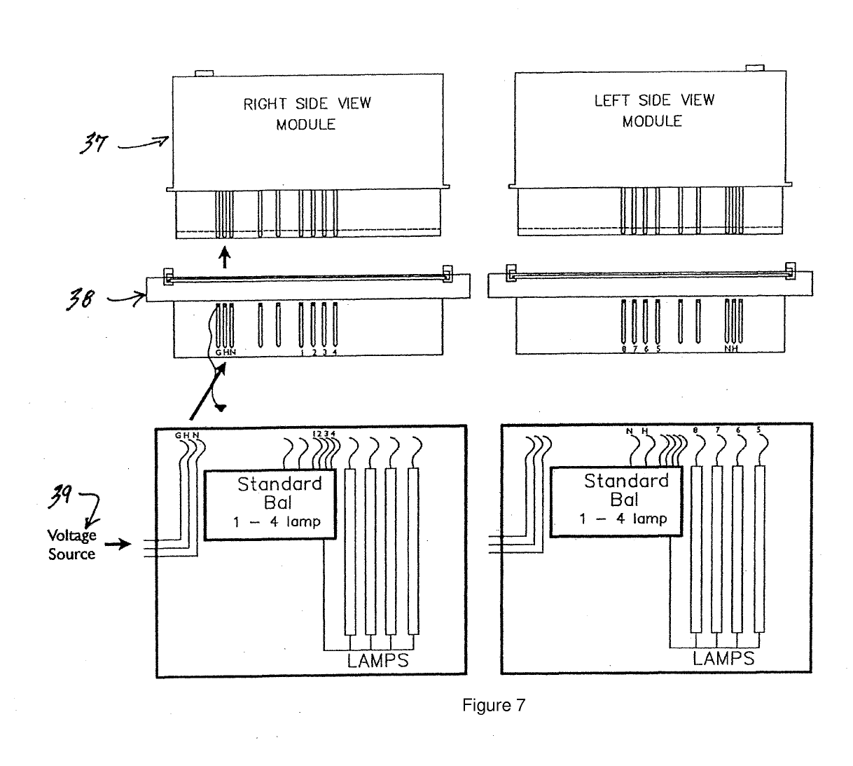

FIG. 7 depicts a Wireless Control Module powered through the Docking Apparatus from a variety of voltage sources of a device for monitoring and controlling the operation of an individual piece of Utilization Equipment or an Alternate Electrical Source according to one or more embodiments shown and described herein.

As illustrated in FIG. 1 the Operating Environment 1 comprises a Computer System 2 connected to one or more Radio Frequency Transceivers 3. RF Transceivers wirelessly communicate 4 using radio frequencies and a protocol with one or more Wireless Control Modules 5. Wireless Control Modules each contain a unique Radio Frequency Identification 6 (RFID) tag.

Each Wireless Control Module is linked to an individual piece of Utilization Equipment 7 and/or to an Alternate Electrical Source 8 through a Docking Apparatus 9. Wireless Control Module functions may include, but are not limited to, receiving instructions in the form of commands sent from a Computer System via the RF Transceiver; executing those commands; taking of measurements; and collecting other data that is then sent back to a Computer System via the RF Transceiver.

The function of a Computer System as illustrated in FIG. 1 is to provide the system operator with overall management and control of all Wireless Control Modules within the Operating Environment. Generally, a Computer System comprises a programmable computer with a user interface, a computer display screen, a mouse, a keyboard, a database, I/O ports suitable for communicating with one or more Wireless Control Modules. More specifically, a Computer System may, but is not limited to, provide real-time and historical visibility to electrical usage; performance data of each piece of Utilization Equipment to which a Wireless Control Module is linked; management and control over the source of electrical supply as well as the amount of electricity consumed by each individual piece of Utilization Equipment.

One or more Radio Frequency (RF) Transceivers are linked to a Computer System. A Computer System passes instructions to the RF Transceiver. The RF Transceiver wirelessly communicates requests for information and commands to one or more Wireless Control Modules using radio frequency communication. RF Transceivers also receive information from one or more Wireless Control Modules and pass that information on to a Computer System. A RF Transceiver comprises, but is not limited to, a radio and one or more antenna.

A Wireless Control Module is a device that monitors, measures and controls the operation of an individual piece of Utilization Equipment and/or an Alternate Electrical Source to which it is linked. Every individual piece of Utilization Equipment and Alternate Electrical Source is linked to a separate Wireless Control Module through a Docking Apparatus. Each Wireless Control Module maintains a unique identity via an embedded removable electronic radio frequency identity (RFID) tag; wirelessly communicates with the Computer System via one or more RF Transceivers and a RFID tag; accepts commands issued from the Computer System as transmitted from a RF Transceiver; executes those commands; takes measurements; gathers information; and wirelessly communicates a variety of data and information back to the Computer System via a RF Transceiver.

The Docking Apparatus is used to connect a Wireless Control Module to a piece of Utilization Equipment.

The function of the Alternate Electrical Source (e.g.: a generator, solar, wind power, fuel cell, etc.) is to provide an alternate and/or supplemental electrical power source to that provided by the Electrical Utility supplier.

Utilization Equipment is any product or piece of equipment that utilizes electric energy for electronic, electromechanical, chemical, heating, lighting, or similar purposes. The function of a piece of Utilization Equipment (e.g.: a light fixture, a motor, HVAC, range/oven, dryer, etc.) is to fulfill its designed purpose for the user.

The description of electrical and mechanical components and parts comprising a Wireless Control Module is as follows:

| Component | Function |
|---|---|
| Circuit Board | Thin rigid board containing electric circuits and |
| | electronic components |
| Electronic Circuit | System of electrical conductors and |
| | components forming a complete and closed |
| | path around which a circulating electric |
| | current can flow |
| Microprocessor | Integrated circuit that contains the functions of |
| | a central processing unit of a computer used to |
| | process and execute commands |
| Electrical Switching | Device for making and breaking the |
| Mechanism | connection in an electric circuit |
| Transducer | Device that converts variations in a physical |
| | quantity, such as pressure or brightness, into |
| | an electrical signal, or vice versa |
| Voltage Sensor | Device that detects or measures voltage and |
| | records, indicates, or otherwise responds to it |

| Component | Function |
|---|---|
| Electrical Current | Device that detects or measures electrical |
| Transformer | current and records, indicates, or otherwise |
| | responds to it |
| Dimmer | Device for varying the brightness of a piece of |
| | Utilization Equipment |
| Voltage Supply | Stock of a resource from which a Wireless |
| | Control Module can be provided with the |
| | necessary amount of that resource |
| Fuse | Safety device consisting of a strip of wire that |
| | melts and breaks an electric circuit if the |
| | current exceeds a safe level |
| Plug-in Radio Frequency | Removable electronic device comprising a |
| Identification (RFID) | unique identity, an integrated circuit (chip), |
| Tag | memory and antenna used to communicate with |
| | a RF Transceiver |
| Case | The outer protective container designed to |
| | hold and protect the Wireless Control |
| | Module circuitry and components |

The description of electrical and mechanical components and parts comprising a Docking Apparatus is as follows:

| Component | Function |
|---|---|
| Electronic Circuit | System of electrical conductors and |
| | components forming a complete and closed |
| | path around which a circulating electric |
| | current can flow |
| Spring-Loaded Electrical | Connection for the passage of an electric |
| Contact | current from a piece of Utilization Equipment |
| | to a Wireless Control Module by which such a |
| | connection is made |
| Captive-Pressure Wire | Device for keeping two parts of an electric |
| Connector | circuit from a piece of Utilization Equipment |
| | to a Docking Apparatus in contact |
| Spring-Loaded | Moveable doors used to protect the Docking |
| Retractable Dust Cover | Apparatus electronic circuitry when a Wireless |
| | Control Module is not inserted |

| Component | Function |
|---|---|
| Latch | Moveable locking mechanism that catches |
| | when a Wireless Control Module is inserted |
| | into the Docking Apparatus used to secure the |
| | Wireless Control Module to the Docking |
| | Apparatus |
| Case | The outer protective container designed to |
| | hold and protect the Docking Apparatus |
| | circuitry and components |

The main function of the Wireless Control Module is to wirelessly communicate with a Computer System; provide a unique RFID identity; to receive requests for information and commands issued from a Computer System; to execute those requests and commands; and to communicate a variety of data and information back to a Computer System.

Wireless Control Modules comprise electronic circuitry and any electrical component capable of interacting with a piece of Utilization Equipment and/or an Alternate Electrical Source in response to specific commands; measurements; and/or the collection, storage and transmission of data.

As illustrated in FIG. 2, the electrical and mechanical components of a Wireless Control Module may include, but are not limited to, one or more of the following: microprocessor 40; circuit board 10; electronic circuit 11; electrical switching mechanism 12; transducer 13; voltage sensor 14; dimmer 16; voltage supply 17; fuse 18; plug-in Radio Frequency Identification (RFID) tag with integrated circuit (chip), antenna and memory 19; line-voltage power port 20; and a case 21 which houses the electrical and mechanical components.

As illustrated in FIG. 3 the electrical and mechanical components of the Docking Apparatus may include, but are not limited to, one or more of the following: electronic circuit; spring-loaded electrical contact 22; captive pressure wire connector 23; spring-loaded retractable dust cover 24; latches 25 to secure a Wireless Control Module to the Docking Apparatus; and a case 26 which houses the electrical and mechanical components.

A Wireless Control Module and a Docking Apparatus can be provided as one unit.

To connect to a piece of Utilization Equipment a Wireless Control Module 27 plugs-in to a Docking Apparatus 28, as illustrated in FIG. 4, that is physically attached to the piece of Utilization Equipment.

As illustrated in FIG. 5, the Docking Apparatus 29 is attached and hardwired to a piece of Utilization Equipment. To hardwire the Docking Apparatus to a piece of Utilization Equipment 30 (in this example: a florescent lamp fixture containing 4 lamps and a Standard Ballast) the user strips the insulation from the end of each wire 31 (in this illustration the wires are labeled G, H, N, 1, 2, 3, 4, 5, 6, 7, 8). The stripped wire ends are then inserted into its corresponding captive pressure wire connector 32 on the Docking Apparatus. The procedure by which wires from the piece of Utilization Equipment are hardwired to the Docking Apparatus depends on the specific type of Utilization Equipment being incorporated.

FIG. 6 illustrates a different example of the Docking Apparatus 33 hardwired to a piece of Utilization Equipment 34 (in this example: a florescent lamp fixture containing 4 lamps and a Dimming Ballast). In addition to those illustrated in FIG. 5 the user strips the insulation from the end of each wire 35 (in this illustration the wires are labeled 10, 11, 12, 13). The stripped wire ends are then inserted into its corresponding captive pressure wire connector 36 on the Docking Apparatus.

As illustrated in FIG. 7 the Wireless Control Module 37 is powered through the Docking Apparatus 38 from a variety of voltage sources 39, including, but not limited to, sources at standard electrical voltages up to 480 volts. Wireless Control Modules also convert those standard voltages to deliver low voltage levels that drive the electronics within the Wireless Control Module; accommodate single phase and three phase current; are designed to link to a piece of Utilization Equipment; and/or an Alternate Electrical Source; and/or an electrical wall outlet; and support plug-in devices via a line-voltage power port.

In a similar manner, when linked to an Alternate Electrical Source the Wireless Control Module receives its electric power through the Docking Apparatus from the same electrical circuit that powers the Alternate Electrical Source to which it is linked.

Wireless Control Modules communicate with a Computer System utilizing an over-the-air radio frequency and protocol to communicate between the RFID tag embedded within each Wireless Control Module and one or more radio frequency Transceivers linked to a Computer System.

Each Wireless Control Module has a Radio Frequency Identification (RFID) tag embedded within it. The RFID tag comprises, but is not limited to, an integrated circuit, an antenna and memory. Each RFID tag contains a unique identification number and other data that is communicated to the Computer System.

Wireless Control Modules comprise electronic circuitry and electrical components capable of interacting with the Utilization Equipment and/or Alternate Electrical Source in response to taking of measurements; and/or the collection, storage and transmission of data. Electrical components used to take measurements may include, but are not limited to, one or more voltage sensors and electrical current transformers. Electrical current transformers may be of a removable (plug-in) type when they are exterior to the Wireless Control Module case or they may be non-removable when included inside the Wireless Control Module case.

Specific to the piece of Utilization Equipment or to the Alternate Electrical Source to which a Wireless Control Module is linked, the Wireless Control Module utilizes one or more voltage sensors and electrical current transformers to measure electrical current and voltage; recognize the piece of Utilization Equipment's present operating state (e.g.: on, off, dimmed, speed, position, etc.); and measure state-of-health.

Wireless Control Modules use, but are not limited to, radio frequency and protocol to establish wireless communication between the embedded RFID tag and the RF Transceiver. The RFID tag transmits information, operating state, state-of-health conditions and other data to the RF Transceiver that then passes the information on to the Computer System.

A Computer System generates a command or request for information and passes this on to the RF Transceiver. The Wireless Control Module uses, but is not limited to, radio frequency and protocol to establish wireless communication between the embedded RFID tag and the RF Transceiver. The RFID tag receives commands and requests for information and passes the command or request on to the logic within the Wireless Control Device for execution.

Once a Wireless Control Module receives a command or a request for information the computer logic resident within the Wireless Control Module attempts to execute the command. Upon receipt, the RFID tag passes the command on to the microprocessor. The microprocessor uses its internal logic to validate the command, interpret its meaning and determine what action is to be taken. The microprocessor processes the command by sending instructions to the appropriate component (for example: the electrical switching mechanism; transducer; voltage sensor; dimmer) within the Wireless Control Module. Examples of commands received and actions to be taken include, but are not limited to: turn on; turn off; dim; speed up; slow down; measure; collect information; and send information.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A device for monitoring and controlling the operation of an individual piece of Utilization Equipment or an Alternate Electrical Source, the device comprising a Wireless Control Module linked to an individual piece of Utilization Equipment or an Alternate Electrical Source via a Docking Apparatus, wherein:
the Wireless Control Module comprises a unique Radio Frequency Identification (RFID) tag and wirelessly communicates with a Computer System connected to one or more Radio Frequency Transceivers in an Operating Environment using radio frequency communication;
the RF Transceivers wirelessly communicate using radio frequencies and a protocol with one or more Wireless Control Modules;
the Wireless Control Module is a device that monitors, measures and controls the operation of an individual piece of Utilization Equipment or an Alternate Electrical Source to which it is linked;
the Wireless Control Module communicates with the Computer System via one or more RF Transceivers and the RFID tag, accepts commands issued from the Computer System as transmitted from a RF Transceiver, executes those commands, takes measurements, gathers information, and wirelessly communicates a variety of data and information back to the Computer System via a RF Transceiver;
the Docking Apparatus connects a Wireless Control Module to a piece of Utilization Equipment or an Alternate Electrical Source;
the Computer System provides a system operator with overall management and control of a plurality of Wireless Control Modules within the Operating Environment and comprises a programmable computer with a user interface, a computer display screen, a mouse, a keyboard, a database, and I/O ports suitable for communicating with one or more Wireless Control Modules; and
the Computer System further provides real-time and historical visibility to electrical usage, performance data of each piece of Utilization Equipment to which a Wireless Control Module is linked, and management and control over the source of electrical supply as well as the amount of electricity consumed by each individual piece of Utilization Equipment.

2. A device for monitoring and controlling the operation of an individual piece of Utilization Equipment or an Alternate Electrical Source of claim 1 wherein the Wireless Control Module and the Docking Apparatus are provided as one unit.

3. A device for monitoring and controlling the operation of an individual piece of Utilization Equipment or an Alternate Electrical Source of claim 1 wherein Wireless Control Module functions include receiving instructions in the form of commands sent from a Computer System via the RF Transceiver; executing those commands; taking of measurements; and collecting other data that is then sent back to a Computer System via the RF Transceiver.

4. A device for monitoring and controlling the operation of an individual piece of Utilization Equipment or an Alternate Electrical Source of claim 1 wherein individual pieces of Utilization Equipment or Alternate Electrical Sources are linked to a separate Wireless Control Module through a Docking Apparatus.

5. A device for monitoring and controlling the operation of an individual piece of Utilization Equipment or an Alternate Electrical Source of claim 1 wherein:
one or more Radio Frequency (RF) Transceivers are linked to the Computer System;
the Computer System passes instructions to the RF Transceiver;
the RF Transceiver wirelessly communicates requests for information and commands to one or more Wireless Control Modules using radio frequency communication; and
the RF Transceivers also receive information from one or more Wireless Control Modules and pass that information on to the Computer System.

6. A device for monitoring and controlling the operation of an individual piece of Utilization Equipment or an Alternate Electrical Source of claim 1 wherein the function of the Alternate Electrical Source is to provide an alternate and/or supplemental electrical power source to that provided by the Electrical Utility supplier.

7. A device for monitoring and controlling the operation of an individual piece of Utilization Equipment or an Alternate Electrical Source of claim 1 wherein the Alternate Electrical Source comprises a generator, a solar power source, a wind power source, or a fuel cell.

8. A device for monitoring and controlling the operation of an individual piece of Utilization Equipment or an Alternate Electrical Source of claim 1 wherein the Utilization Equipment is a piece of equipment that utilizes electric energy for electronic, electromechanical, chemical, heating, or lighting.
